(19) United States
(12) Patent Application Publication
(10) Pub. No.: US 2011/0175476 A1
(43) Pub. Date: Jul. 21, 2011

(54) FREE-EJECTING STARTER

(76) Inventor: Juergen Kugler, Loechgau (DE)

(21) Appl. No.: 12/736,904

(22) PCT Filed: May 25, 2009
(86) PCT No.: PCT/EP2009/056269

§ 371 Date: Mar. 10, 2011

(30) Foreign Application Priority Data
May 30, 2008 (DE) 10 2008 002 115.6

(51) Int. Cl. H02K 7/116

(52) U.S. Cl. 310/83

(57) ABSTRACT

A free-ejecting starter for cranking an internal combustion engine in a vehicle includes a pinion shaft, which at the front, free-ejecting end, has an engaging pinion and a pinion shank at the opposite end which is guided and supported slidably on a drive shaft of the starter and accommodated in a bearing by a bearing shield of the starter. The pinion shank has a first, outer bearing section which is directly supported on the drive shaft.

### BACKGROUND OF THE INVENTION

1. Field of the Invention

The present invention relates to a free-ejecting starter for cranking an internal combustion engine in a vehicle, having a pinion shaft, which at the front, free-ejecting end, has a engaging pinion and, at the opposite end, a pinion shank which is guided and supported slidably on a drive shaft of the starter and accommodated in a bearing by a bearing shield of the starter.

2. Description of Related Art

Free-ejecting starters are known which have a engaging pinion, also referred to as a starter pinion, which is supported on the drive shaft of the starter using two bearing sleeves or bushings or one very wide bearing bushing. Using a relay, the engaging pinion is engaged with an annular gear for starting the internal combustion engine and is disengaged again after the internal combustion engine is started.

Another embodiment of the starter is represented by so-called jaw starters in which the starter pinion is supported on the face of the drive shaft.

The engaging pinion is rotatably supported on the drive shaft of the starter, since after the internal combustion engine is started with the aid of the engaging pinion, the internal combustion engine causes the rotational speed of the engaging pinion to overrun the rotational speed of the drive shaft of the starter. The relative rotational speed of the pinion shank in relation to the drive shaft occurs for only a few seconds when the internal combustion engine is run up. Otherwise, the rotational speed and remaining operating time of the engaging pinion is equal to that of the drive shaft. The pinion shaft is coupled to an overrunning clutch on the drive shaft for the starting operation. The overrunning clutch ensures that torque is transferred to the pinion shaft during the starting operation and allows a higher relative rotational speed in relation to the drive shaft. The operating time of the relative rotational speed, i.e., load time of the bearing of the pinion shaft on the drive shaft, is thus very short overall compared to the total operating time. Over the life of a vehicle, the operating time typically adds up to approximately 12 hours.

To achieve a substantially longer service life compared to conventionally sintered bearing bushings or pocket bushings in which lubricants are accommodated in formed pockets, published German patent application document DE 197 43 122 A1 describes a free-ejecting starter having at least one front bearing point of a pinion shank on the drive shaft in the form of a needle bearing. Such conventional starters are complex with regard to the bearing support.

An object of the present invention is to refine a free-ejecting starter of the type mentioned at the outset, in such a way that the structure and assembly of the starter is simplified and made more cost-effective.

### BRIEF SUMMARY OF THE INVENTION

An essential inventive idea is to design the bearing support of the pinion shaft on the drive shaft in line with demands. Roller bearings or sintered bearing bushings are designed for an operating life of several hundred to a thousand hours. In the typical use case, the effective operating life of the bearing of the pinion shaft on the drive shaft is only 10 to 12 hours. For that reason, a significant idea of the present invention is that this bearing support be designed in line with the requirements and not oversized, thus achieving simplified manufacturing with reduced weight.

The object is achieved using a starter in that the pinion shank has at least one first, inner bearing section which is supported directly on the drive shaft. The idea is to support the pinion shank, which is manufactured from a hard material, in turn on a hard material of the drive shaft. This bearing support could thus be described as a hard-hard bearing support compared to a hard-soft-hard bearing support having a sintered bearing sleeve manufactured from a soft material situated between the pinion shaft and the drive shaft. A significant advantage is that fewer components are needed, more rapid production of the components and the starter is possible, and fewer components make it possible to achieve a weight reduction and lower manufacturing costs overall. The production is simpler. Moreover, the encapsulated structure protects the bearing support very well against occurring environmental conditions such as dust, clutch abrasion, moisture, etc., in contrast to so-called jaw starters.

The bearing support may among other things also be simplified in that, for example, it is not necessary to use a complex and expensive roller bearing such as must be used in the related art described at the outset, because at the point in time at which a relative rotational speed arises between the pinion shaft and drive shaft, it is not necessary to transfer torque from the starter to the annular gear of the internal combustion engine. At this point in time, the load state, i.e., the force acting on the pinion, is very small. Furthermore, the operating time is further reduced by short cycles, for example, in vehicles having starting systems including a starting time control without a direct intervention by the driver. Vehicles having a start button or a start key have a starting time control which stops the starter even faster and disengages the engaging pinion from the annular gear as soon as the internal combustion engine has been started.

For the aforementioned reasons, it is possible to eliminate all previously known bearing elements between the pinion shaft and the drive shaft.

According to another example embodiment, a lubricant is applied to the at least one bearing section of the pinion shaft on the drive shaft in order to design the bearing support to be smooth-running and with reduced noise, and to prevent corrosion. This lubricant is, for example, a grease or oil or another lubricant known from the related art which wets the first bearing section or is applied over a large area.

According to another, further example embodiment, the at least one first bearing section may additionally or alternatively have an anti-friction coating. The anti-friction coating may be another material coating, for example, a plastic coating or another abrasion-resistant coating. The plastic coating may be, for example, a Teflon coating.

According to another example embodiment of the present invention, the first bearing section and/or the drive shaft is/are specially hardened in the area in which the bearing section is displaced and supported when bearing on the drive shaft. The special hardening may considerably lengthen the service life. The hardening method may be, for example, a nitriding treatment, or a heat treatment method which may also be used against corrosion.

To improve the service life with regard to smooth operation and noise reduction, a lubricant reservoir is provided according to a particularly preferred specific embodiment. The lubricant reservoir is formed at least on the first bearing section by a lubrication groove on the pinion shaft. Before the pinion shaft is installed on the drive shaft, for example, the lubrication groove is filled with grease and thus lasts over the starter's service life.

The pinion shaft may be situated on the drive shaft using a hard-hard bearing support. For manufacturing reasons, for simplifying the manufacturing of a pinion shaft, the outer bearing section closest to the engaging pinion is directly supported hard on the drive shaft and an inner, second bearing section is supported soft on the drive shaft using a bearing sleeve.

In order to simplify and shorten production, thus making it more advantageous, the inner diameter of the drive shaft is essentially constant over the length of the two bearing sections on which the engaging pinion is supported. This also results in a weight reduction compared to a stepped drive shaft.

In order to significantly reduce the weight of the starter, in particular the bearing support of the pinion shaft on the drive shaft, for reducing the wall thicknesses, the inner diameter of the pinion shank is larger in the area of the second bearing section, preferably up to the first bearing section, than the inner diameter in the area of the engaging pinion up to the first bearing section. This makes the pinion shaft material-optimized and weight-optimized and designed to conserve resources. The wall thicknesses are selected to be sufficiently large that adequate strength is achieved with a maximum reduction in weight.

Advantageously, the first bearing section on the pinion shank is formed downstream from the engaging pinion, resulting in the presence of an open area under the pinion toothing for the stop system including an axial path for displacing the engaging pinion. The bearing support close to the toothing is first preferred in this area. In other stop systems, the bearing support may be formed under the pinion toothing of the engaging pinion.

The object is further achieved using an assembly method in that the pinion shank of the pinion shaft is pushed directly onto the drive shaft. According to the present invention, this significantly simplifies the assembly method, since no roller bearing or a sintered bushing must be used. In particular, an anti-friction coating, in particular a lubricant, for example, grease, is applied to the bearing section. As explained above, a Teflon coating or another lubricant may be applied to the bearing section. The assembly steps are reduced since fewer components are needed. The assembly is faster and accordingly more cost-effective.

### BRIEF DESCRIPTION OF THE DRAWINGS

FIG. 1 shows a schematic cross section of a pinion shaft supported on a drive shaft according to a first example embodiment.

FIG. 2 shows a schematic cross section of a pinion shaft according to a second example embodiment.

### DETAILED DESCRIPTION OF THE INVENTION

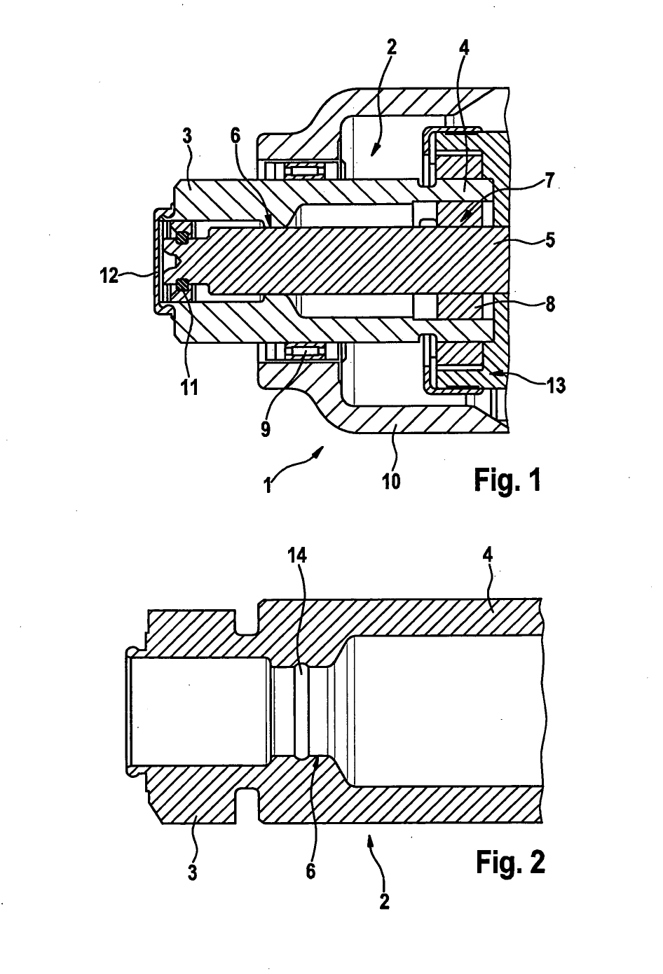

FIG. 1 shows a detail of an enlarged cross section of a starter 1 for cranking an internal combustion engine in a vehicle. Starter 1 is of the type of a so-called free-ejecting starter having a unilaterally supported pinion shaft 2 on which a engaging pinion 3 is formed, which is engaged with an annular gear (not shown) with the aid of a relay for a starting operation of the internal combustion engine and is disengaged again after the internal combustion engine is run up.

Pinion shaft 2 is rotatably supported on a drive shaft 5 of the starter to allow a relative rotational speed which occurs when the internal combustion engine runs up and reaches a higher rotational speed on the annular gear than the starter has predefined via drive shaft 5. This relative rotational speed has a very short operating time in the starting cycle. In particular in modern vehicles having a start button, the operating time is definably shortened, since a starting time control disengages the engaging pinion from the annular gear after the internal combustion engine is started.

Pinion shaft 2 has a first bearing section 6 and a second bearing section 7. First bearing section 6 is an outer one which is closest to engaging pinion 3, and second bearing section 7 is an inner one having a bearing sleeve 8 which is manufactured from a soft material such as, for example, a sintered bronze material. To improve the anti-friction properties and for corrosion protection and noise reduction, bearing sleeve 8 is surrounded by or impregnated with a lubricant. Bearing sleeve 8 may also have a lubricant reservoir in the form of a circumferential groove, a so-called pocket. To bridge a large inner diameter of the pinion shaft, bearing sleeve 8 seen in cross section is preferably designed to be thick, having a large wall material thickness in this specific embodiment.

According to the present invention, pinion shaft 2 on the first bearing section is supported directly on drive shaft 5 without a sintered sleeve or a roller bearing. A hard-hard bearing support is thus present, since the hard material of pinion shaft 2 is supported on the hard material of drive shaft 5. Such a bearing support is adequate, since the operating life of several thousand hours compared to conventional roller bearings and bearing supports in a sleeve is very short overall. The total operating life of the hard-hard bearing support is typically considered to be 10 to 12 hours above the life of the starter. This operating time arises when a relative rotational speed occurs between a pinion shaft 2 and a drive shaft 5.

Pinion shaft 2 is accommodated by a roller bearing 9 which is inserted into a bearing shield 10 of starter 1. To protect the hard-hard bearing support against environmental influences such as dust, moisture, and/or abrasion, a seal cap 12 on the face of engaging pinion 3 entirely caps off the bearing support. The axial one-track movement of engaging pinion 3 is delimited by pinion stop 11 on drive shaft 5. Pinion stop 11 includes a stop ring and a snap ring. Pinion shaft 2 is operatively linked to drive shaft 5 by an overrunning clutch 13, so that engaging pinion 3 is driven by drive shaft 5 with a torque, and in the overrunning case when the internal combustion engine is run up, a relative rotational speed is implementable with a higher rotational speed of engaging pinion 3.

Advantageously, bearing surfaces on first bearing section 6 of drive shaft 5 and/or pinion shaft 2 are specially hardened. They have an anti-friction coating. For manufacturing reasons, the inner diameter is essentially constant over the length of bearing sections 6, 7 on which engaging pinion 3 including pinion shank 4 is supported. The inner diameter of pinion shank 4 is designed to have a significantly larger inner diameter in the area of second bearing section 7 including bearing sleeve 8 up to first bearing section 6 than the bore from the face on engaging pinion 3 up to first bearing section 6. This provides a pinion shaft 2 of thinner wall thicknesses with a significant reduction in weight, which also results in a conservation of material resources compared to a pinion shaft according to the related art.

Advantageously, a free-ejecting starter 1 is thus very simple to assemble. Only a wide, thick bearing sleeve 8 is used on one face which is opposite to the engaging pinion, and pinion shank 4 including at least one bearing section is pushed directly onto the drive shaft providing bearing support.

FIG. 2 shows an enlarged detail in cross section of a pinion shaft 2 in an example embodiment. FIG. 2 shows the detail including engaging pinion 2 in the area around first bearing section 6. According to an example embodiment, bearing section 6 of pinion shaft 2 has a circumferential lubrication groove 14. Lubrication groove 14 is used as a lubricant reservoir to supply bearing section 6 with adequate lubricant during the entire service life. First bearing section 6 is formed on pinion shank 4 upstream from engaging pinion 3.

All figures show only schematic representations which are not to scale.

1-10. (canceled)

11. A free-ejecting starter for cranking an internal combustion engine in a vehicle, comprising:
a pinion shaft having (i) an engaging pinion at a front free-ejecting end and (ii) a pinion shank at an opposite end;
wherein the pinion shank is guided and supported slidably on a drive shaft of the starter and accommodated in a bearing by a bearing shield of the starter, and wherein the pinion shank has at least one first, outer bearing section directly supported on the drive shaft.

12. The starter as recited in claim 11, wherein a lubricant is applied to the at least one first, outer bearing section of the pinion shaft on the drive shaft.

13. The starter as recited in claim 11, wherein the first, outer bearing section has an anti-friction coating.

14. The starter as recited in claim 11, wherein at least one of (i) the first, outer bearing section and (ii) a portion of the drive shaft supporting the first, outer bearing section is hardened.

15. The starter as recited in claim 12, wherein at least the first, outer bearing section has a lubrication groove.

16. The starter as recited in claim 15, wherein the pinion shank has an inner, second bearing section supported on the drive shaft with the aid of a bearing sleeve.

17. The starter as recited in claim 15, wherein the outer diameter of the drive shaft is substantially constant over the length of the first and second bearing sections.

18. The starter as recited in claim 16, wherein the inner diameter of the pinion shank is larger in the area of the second bearing section than in the area of the engaging pinion up to the first bearing section.

19. The starter as recited in claim 16, wherein the first bearing section is formed on the pinion shank downstream from the engaging pinion.

20. A method for manufacturing a free-ejecting starter for cranking an internal combustion engine in a vehicle, comprising:
providing a pinion shaft having (i) an engaging pinion at a front free-ejecting end and (ii) a pinion shank at an opposite end; and
pushing the pinion shank of the pinion shaft directly onto a drive shaft of the starter, wherein the pinion shank is guided and supported slidably on the drive shaft and accommodated in a bearing by a bearing shield of the starter, and wherein the pinion shank has at least one first, outer bearing section directly supported on the drive shaft.
